(19) United States
(12) Patent Application Publication
(10) Pub. No.: US 2013/0293871 A1
(43) Pub. Date: Nov. 7, 2013

(54) SENSOR FOR SPECTRAL-POLARIZATION IMAGING

(71) Applicant: Washington University, St. Louis, MO (US)

(72) Inventor: Viktor Gruev, St. Louis, MO (US)

(21) Appl. No.: 13/866,096

(22) Filed: Apr. 19, 2013

Related U.S. Application Data
(60) Provisional application No. 61/636,178, filed on Apr. 20, 2012.

(51) Int. Cl. G01J 3/28; G01J 4/04

(52) U.S. Cl. CPC G01J 3/2803; G01J 4/04
USPC 356/73

(57) ABSTRACT

A sensor is provided that combines monolithically-integrated pixelated aluminum nanowires with vertically stacked photodetectors. The aluminum nanowires are arranged as a collection of 2-by-2 pixels, or super-pixels. Each super-pixel includes nanowires at four different orientations, offset by 45°. Thus, the optical field is sampled with 0°, 45°, 90°, and 135° linear polarization filters. Due to the spatial subsampling, interpolation may be applied to reconstruct the full 0°, 45°, 90°, and 135° arrays.

### CROSS-REFERENCE TO RELATED APPLICATION

This application claims the benefit of U.S. Provisional Application No. 61/636,178 filed Apr. 20, 2012, which is incorporated herein in its entirety.

### GOVERNMENT INTEREST

Development of the present invention was supported in part by the U.S. Air Force Office of Scientific Research (AFOSR) under grant number FA9550-10-1-0121 and the National Science Foundation (NSF) under grant number 1130897. The government may have certain rights in the invention.

### BACKGROUND

The embodiments described herein relate generally to imaging sensors, and more particularly to division-of-focal-plane (DoFP) spectral-polarization imaging sensors, i.e., monolithically-integrated spectral-sensitive photo elements with an array of pixelated polarization filters.

Humans perceive light intensity and frequency as brightness and color, respectively. Polarization is the third fundamental physical property of light that, although invisible to the human eye, upon detection can provide a previously unexplored insight. Polarization of light caused by reflection from materials contains information about the surface roughness, geometry, and/or other intrinsic properties of the imaged object. Polarization contrast techniques have proven to be very useful in gaining additional visual information in optically scattered environments, such as target contrast enhancement in hazy/foggy conditions, depth map of the scene in underwater imaging, and in normal environment conditions, such as classifications of chemical isomers, classifications of pollutants in the atmosphere, non-contact fingerprint detection, and seeing in the shadow, among others. Moreover, polarization contrast techniques facilitate navigation and enhancement of target contrast in scattering media.

Known polarization imaging sensors can be divided into division of time, division of amplitude, division of aperture, and division of focal plane polarimeters. At least one known polarization imaging sensor includes standard CMOS or CCD imaging sensors coupled with electrically or mechanically controlled polarization filters and a processing unit. Such imaging systems, known as division of time polarimeters, sample the imaged environment with a minimum of three polarization filters offset by either 45 or 60 degrees, and polarization information, i.e. degree and angle of polarization, is computed off-chip by a processing unit. Shortcomings of these systems include a reduction of frame rate by a factor of 3, high power consumption associated with both the processing unit and the electronically/mechanically controllable polarization filters, and polarization information errors due to motion in the scene during the sampling of the three polarization filtered images.

Typically, polarization sensors work over a range of the electromagnetic spectrum, such as the visible and/or infrared regime; however, such sensors are typically oblivious to the wavelengths of light striking them, only detecting the intensity and polarization in a scene. There are a number of possible applications of obtaining spectral data in combination with polarization data. For example, numerous applications exist in astronomy, remote sensing, non-invasive medicine, and computer vision.

Efforts have been made to build a sensor that is capable of perceiving both spectral and polarization data. One such instrument is a division-of-time spectropolarimeter which combines a conventional polarimeter with a rotating spectral filter. Other endeavors include combined channeled polarimetry and computed tomography imaging spectrometry (CTIS) in an effort to combine multispectral imaging and polarimetry, acousto-optic tunable filters, and liquid crystal tunable filters. However, these systems may have disadvantages such as the inability to concurrently record spectral and polarization data, a need for moving parts and heavy computational requirements.

Accordingly, there is a need for a sensor capable of sensing spectral and polarization information with high temporal and spatial resolution. Moreover, a sensor is needed that is compact, robust and has no moving parts. Such a sensor should record spectral and polarization information at every frame with high accuracy.

### BRIEF DESCRIPTION

In one embodiment, a sensor for measuring polarization and spectral information is provided. The sensor includes a polarization assembly including a plurality of polarization filters, and a detection assembly coupled to the polarization assembly. The detection assembly includes a plurality of photodetector assemblies. Each photodetector assembly includes at least two vertically-stacked photodetectors wherein each of the plurality of photodetector assemblies is adjacent to one of the plurality of polarization filters.

In another embodiment, a system for measuring polarization and spectral information is provided. The system includes a sensor having a polarization assembly with a plurality of polarization filters and a detection assembly coupled to the polarization assembly. The detection assembly includes a plurality of photodetector assemblies. Each photodetector assembly includes at least two vertically-stacked photodetectors wherein each of the plurality of photodetector assemblies is adjacent to one of the plurality of polarization filters. The system further includes a computing device communicatively coupled to the sensor wherein the computing device is programmed to receive polarization and spectral information from the sensor.

In yet another embodiment, a method for measuring polarization and spectral information is provided. The method includes receiving data from a sensor wherein the sensor includes a polarization assembly including a plurality of polarization filters and a detection assembly coupled to the polarization assembly. The detection assembly includes a plurality of photodetector assemblies. Each photodetector assembly includes at least two vertically-stacked photodetectors wherein each of the plurality of photodetector assemblies is adjacent to one of the plurality of polarization filters. The method further includes interpolating polarization components for each photodetector assembly based on the received data, and generating an image having polarization and spectral information.

### BRIEF DESCRIPTION OF THE DRAWINGS

The embodiments described herein may be better understood by referring to the following description in conjunction with the accompanying drawings.

FIG. 1 is a perspective view of an exemplary sensor.

FIG. 2 is a top view illustrating a portion of an exemplary polarization assembly for use with the sensor shown in FIG. 1.

FIG. 3 illustrates an exemplary photodetector assembly for use with the sensor shown in FIG. 1.

FIGS. 4A and 4B illustrate the absorption depth of light at various wavelengths.

FIG. 5 is an exemplary method for use of the sensor shown in FIG. 1.

FIG. 6 is an exemplary computing device for use with the sensor in FIG. 1.

### DETAILED DESCRIPTION OF THE DRAWINGS

While the making and using of various embodiments of the present disclosure are discussed in detail below, it should be appreciated that the present disclosure provides many applicable inventive concepts that can be embodied in a wide variety of specific contexts. The specific embodiments discussed herein are merely illustrative of specific ways to make and use the disclosure and do not delimit the scope of the disclosure.

To facilitate the understanding of the embodiments described herein, a number of terms are defined below. The terms defined herein have meanings as commonly understood by a person of ordinary skill in the areas relevant to the present disclosure. Terms such as “a,” “an,” and “the” are not intended to refer to only a singular entity, but rather include the general class of which a specific example may be used for illustration. The terminology herein is used to describe specific embodiments of the disclosure, but their usage does not limit the disclosure, except as outlined in the claims.

As described in more detail herein, a sensor is provided that combines monolithically-integrated pixelated aluminum nanowires with vertically-stacked photodetectors. The aluminum nanowires are arranged as a collection of 2-by-2 pixels, or super-pixels. Each super-pixel includes nanowires at four different orientations, offset by 45°. Thus, the optical field is sampled with 0°, 45°, 90°, and 135° linear polarization filters. Due to the spatial subsampling, interpolation may be applied to reconstruct the full 0°, 45°, 90°, and 135° arrays. The combination of an imaging array with a micropolarization filter array is known as a division-of-focal-plane (DoFP) sensor.

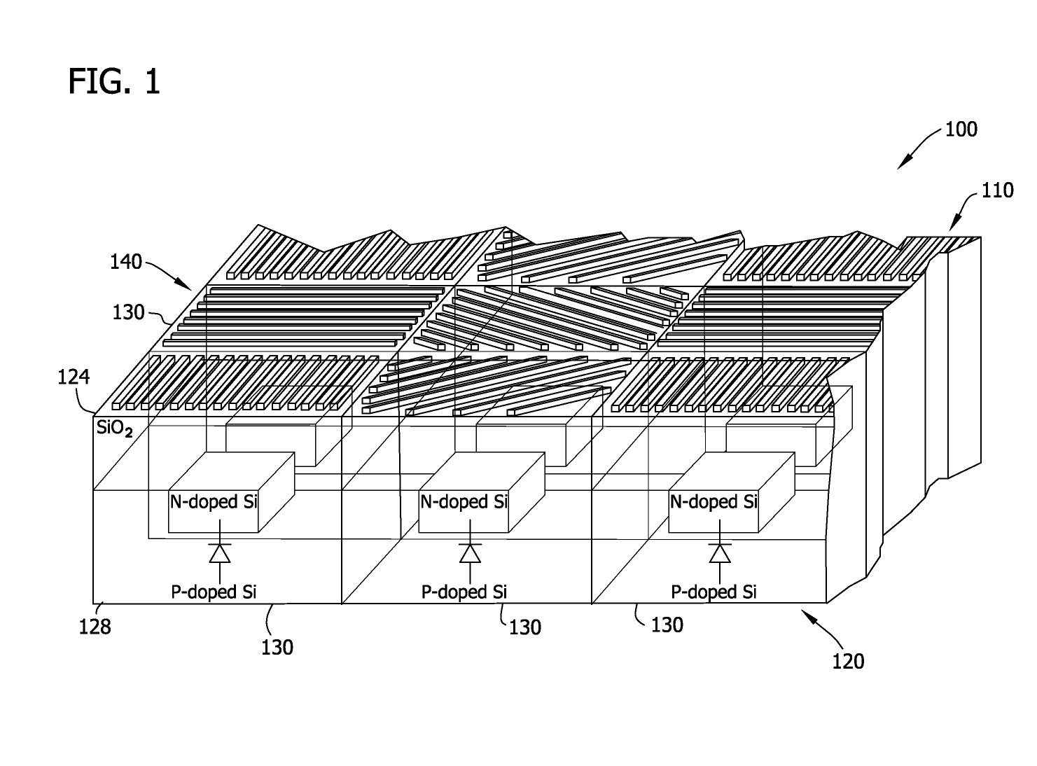

FIG. 1 is a perspective view of an exemplary sensor 100 for measuring polarization and spectral information. Sensor 100 includes a polarization assembly 110 and a detection assembly 120. Polarization assembly 110 includes a plurality of polarization filters 124, and detection assembly 120 includes a plurality of photodetector assemblies 128. Polarization assembly 110 is coupled to detection assembly 120 such that incoming light is filtered through at least one polarization filter 124 before reaching photodetector assemblies 128, as described in more detail herein. In the exemplary embodiment, polarization assembly 110 is deposited directly onto photodetectors 128. Sensor 100 is divided into a plurality of pixels 130 and a plurality of super-pixels 140. In the exemplary embodiment, each super-pixel 140 includes four pixels 130. Alternatively, super-pixels 140 may include any number of pixels 140 that enable sensor 100 to function as described herein.

Using the combination of polarization assembly 110 and detection assembly 120, sensor 100 can simultaneously acquire spectral and polarization information with a relatively high spatial and temporal resolution. Further, sensor 100 is relatively compact, lightweight, and robust. For example, in one embodiment, sensor 100 has dimensions of 2 inches by 3 inches by 5 inches, a framerate of approximately 30 frames per second, an electron sensitivity of 0.06 DV/electron, and a power consumption of 250 milliwatts (mW).

Each pixel 130 includes one polarization filter 124 and one photodetector assembly 128. Each photodetector assembly 128 is capable of detecting light and converting the detected light into electrical signals. In the exemplary embodiment, photodetector assemblies 128 are capable of detecting three color components of light, i.e., red, green, and blue (RGB). Alternatively, or additionally, photodetector assemblies 128 may be configured to detect more than three colors, or ranges of wavelengths. In the exemplary embodiment, sensor 100 has an array size of 168 by 256 pixels, with a pixel pitch of 5 μm. However, it should be appreciated that sensor 100 may include any number of pixels, with any suitable pixel pitch, that enables sensor 100 to function as described herein.

Each photodetector assembly 128 is formed by alternatively stacking different types of conductive type regions. For example, the first layer contains a particular conductive type such as positive-doped material. The second layer contains a conductive type material that is opposite to the first one. In this example, the second layer is negatively doped material. The third layer contains a conductive type material that is opposite to the second one and so on. The alternative stacking of different types of conductive materials can be achieved via several different fabrication procedures, including but not limited to doping, epitaxial grown material, deposition and other.

Light is a transverse wave that is fully characterized by the intensity, wavelength and polarization of the wave. Transverse waves vibrate in a direction perpendicular to their direction of propagation.

Depending on the direction of the vibrations described on an X-Y plane, a transverse wave can be linearly polarized, partially linearly polarized, circularly polarized, or unpolarized. For example, if the vibrations of the wave are consistent in a particular direction, the electromagnetic wave, i.e. the light wave, is linearly polarized. If the vibrations of the wave are predominant in a particular direction and vibrations in other directions are present as well, the light wave is partially linearly polarized. Circularly polarized light describes circular vibrations in the X-Y plane due to the +/−π/2 phase difference between the two orthogonal components of the electric-field vector. Unpolarized light vibrates randomly in the plane of propagation and does not form any particular shape on the X-Y plane. In some representations, linearly polarized light describes a line, partially polarized light describes an ellipse, and circularly polarized light describes a circle on the X-Y plane.

In order to capture the polarization properties of light, three parameters are of importance: the intensity of the wave, the angle of polarization (AoP) and the degree of linear polarization (DoLP). For example, in the case of partially polarized light, the major axis of the ellipse describes the angle of polarization, while the minor axis of the ellipse describes the degree of polarization. If the minor axis is nonexistent, the ellipse degenerates to a line and the light is linearly polarized. If the light wave is unpolarized, the degree of polarization is zero and there is no major axis of vibration. If light is left (right) handed circularly polarized, the oscillations in the X-Y plane are clockwise (counter clockwise).

The primary parameters of interest when discussing polarization in DoFP sensors are the degree of linear polarization (DoLP) and the angle of polarization (AoP). The DoLP ranges from 0 to 1 and describes how linearly polarized the incident light is. For example, linearly polarized light will have DoLP of 1 and unpolarized light will have DoLP of 0. The AoP is the orientation of the plane of oscillation of the light wave and ranges from 0° to 180°. These properties are computed using the intermediary Stokes' parameters. The Stokes' parameters are given by

S₀=½(I₀+I₄₅+I₉₀+I₁₃₅), (Eq. 1)

S₁=I₀−I₉₀, (Eq. 2)

S₂=I₄₅−I₁₃₅, (Eq. 3)

where I₀, I₄₅, I₉₀ and I₁₃₅ are the intensities of the incident light wave sampled after filtering it with 0°, 45°, 90°, and 135° linear polarization filters.

In equations (1) through (3), I₀ is the intensity of the e-vector filtered with a 0 degree polarizer and no phase compensation between the x and y components; I₄₅ is the intensity of the e-vector filtered with a 45 degree polarizer and no phase compensation as above; and so on. The first three Stokes parameters fully describe the polarization of light with two linearly polarized intensities and the total intensity of the e-field vector. Therefore, in order to fully describe the polarization state of light in nature, for which the phase information between the components is not available, three linearly polarized projections or two linearly polarized projections in combination with the total intensity are needed. The latter method only requires two thin film polarizers offset by 45 degrees, patterned and placed on neighboring pixels. Thus, while the exemplary embodiment includes polarization filters 124 with four orientations, only two orientations are required. Polarization assembly 110 may include polarization filters 124 having any number of different orientations, such as two, three, four, or more. The overall thickness of the complete filter will be thinner for a two-tier vs. a three-tier filter, which has two main advantages. The first advantage is in minimizing light attenuation through multiple layers and increasing the angle of incidence. The second advantage is in reduction of fabrication steps and minimization of alignment errors.

AoP and DoLP are calculated as

AoP=(½) tan⁻¹(S₂/S₁), (Eq. 4)

DoLP=\sqrt{S₁²+S₂²}/S₀. (Eq. 5)

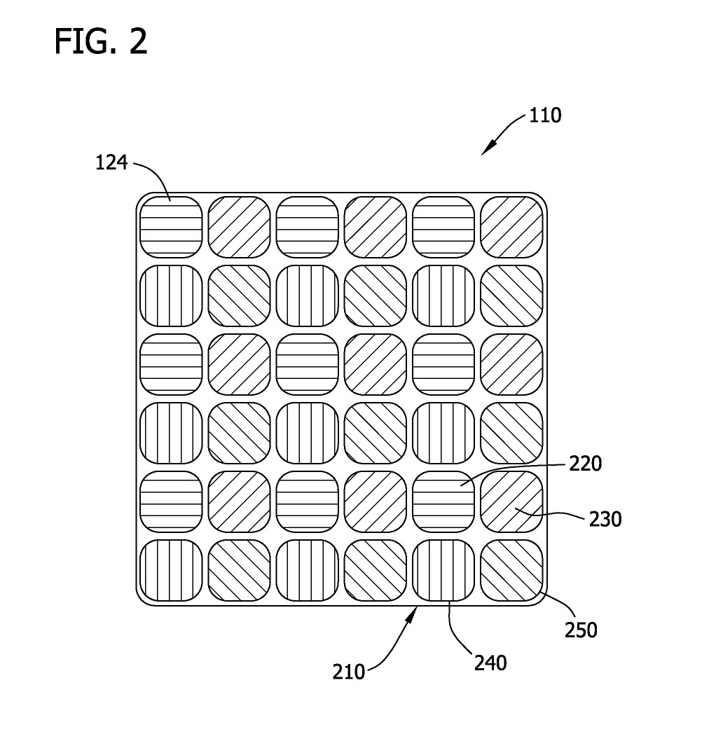

FIG. 2 is a top view illustrating a portion of an exemplary polarization assembly 110 for use with sensor 100. In the exemplary embodiment, polarization assembly 110 includes polarization filters 124 having one of four orientations: 0°, 45°, 90°, and 135°. A super-pixel 210 includes a first polarization filter 220, a second polarization filter 230, a third polarization filter 240, and a fourth polarization filter 250. First polarization filter 220 is oriented at 0°, second polarization filter 230 is oriented at 45°, third polarization filter 240 is oriented at 90°, and fourth polarization filter 250 is oriented at 135°.

In the exemplary embodiment, polarization filters 124 use aluminum nanowires. The nanowires have a 140-160 nm pitch, 70-80 nm width, and 70-160 nm height. For example, in one embodiment, the nanowires have a 140 nm pitch, a 70 nm width, and a 70 nm height. Alternatively, or additionally, polarization filters 124 may include polymers, holes, slits, crystals and/or any other filter that enables sensor 100 to function as described herein. Reference is made to U.S. Pat. No. 7,582,857 to Gruev et al., which is hereby incorporated by reference in its entirety.

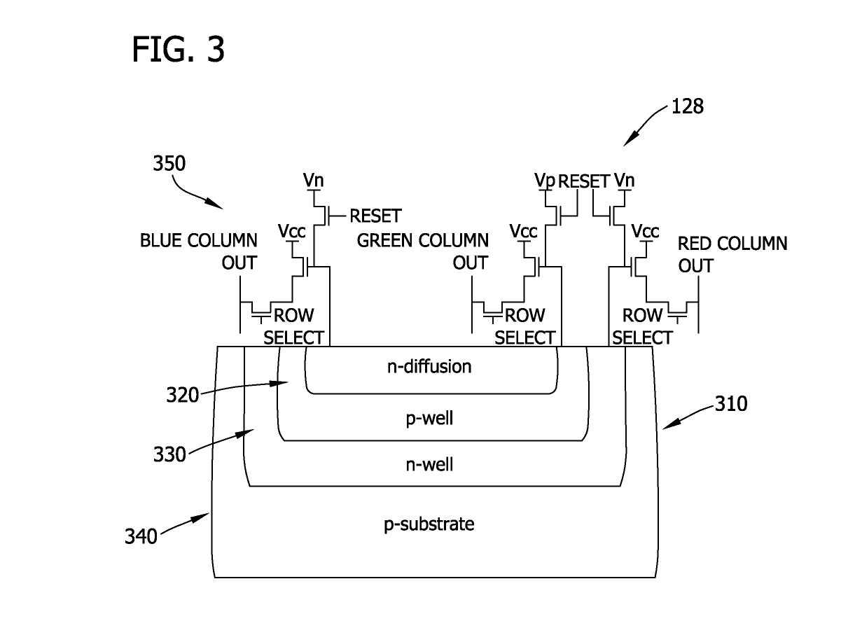

FIG. 3 illustrates an exemplary photodetector assembly 128 for use with sensor 100. Detection assembly 120 forms the substrate of sensor 100 and includes photodetector assemblies 128 in the form of vertically-stacked photodetectors 310. Detection assembly 120 may be a CMOS, CCD, and/or any other semiconductor that enables sensor 100 to function as described herein. In the exemplary embodiment, each photodetector assembly 128 registers the spectral content of the incoming filtered light in the form of a 10-bit intensity value for each channel (e.g., blue, green, red).

In known color image sensors, an array of photodiodes is covered with a Bayer pattern, where a neighborhood of 2 by 2 pixels records blue, green and red components of the incident light. In these image sensors, spectral information is computed in the neighborhood of these pixels with three inherent limitations. The first limitation is color interpretation inaccuracy due to the spatial distribution of the three differently filtered pixels. The color inaccuracy is especially pronounced in highly structured scenes, i.e., in high frequency components, such as edges of objects. The second limitation is loss of spatial resolution. The effective resolution of an image sensor with Bayer pattern is reduced by a factor of 4 if interpolation algorithms are not used. The third limitation is limited spectral information recorded using three broadband optical filters. Interpolation algorithms are employed in such known image sensors in order to partially recover the loss of spatial resolution and to improve the accuracy of color interpretation.

In order to address the loss of spatial information and misinterpretation of spectral information, each photodetector 310 captures a portion of the electromagnetic spectrum such that each pixel 130 and photodetector assembly 128 captures at least red, green, and blue color components. Without being limited to any particular theory, the underlying physical principle for the operation of detection assembly 120 is that silicon absorbs light at a depth proportional to the incident wavelength. This behavior is given by the following relationship:

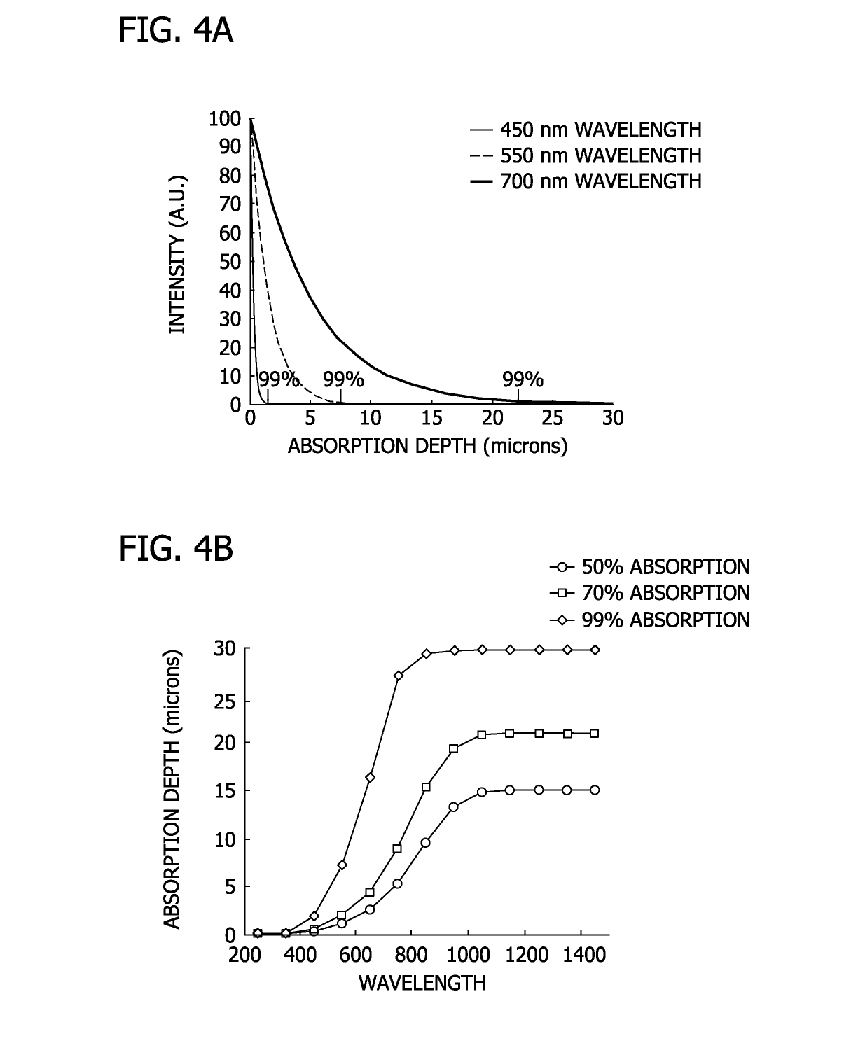

I=I₀×exp(−αx) (Eq. 6)

where I gives the number of photons absorbed at depth x, I₀ is the light intensity or number of photons at the surface of photodetector assembly 128 and a is the absorption coefficient. The coefficient a depends on the wavelength of the incident light. The relationship given by Eq. 6 can be observed in FIGS. 4A and 4B. FIG. 4A shows the depths at which 99% of incident light is absorbed for three different wavelengths. FIG. 4B demonstrates the absorption depths when 50%, 70%, or 99% of incident photons are captured. For example, if a monochromatic light wave at 550 nm is incident on the surface of silicon, then 50% of the incident light will be absorbed by a depth of 10 microns.

In the exemplary embodiment, shown in FIG. 3, a top photodetector 320, placed at 0.2 μm depth, is most sensitive to blue light; a middle photodetector 330, placed at 0.56-0.8 μm depth, is most sensitive to green light; and a bottom photodetector 340, placed at 2-3 μm depth, is most sensitive to red light. A circuit 350 is coupled to photodetector assembly 310.

In the exemplary embodiment, detection assembly 120 responds over a spectrum of 300-850 nm. A quantum efficiency of each photodetector 310 is defined as a ratio of the number of photos at a particular wavelength striking the surface of the particular photodetector 310 to the number of electron-hole pairs registered by the particular photodetector 310. In one embodiment, top photodetector 320 responds in the 370 to 550 nanometer range with a peak quantum efficiency of 41% at 460 nm, middle photodetector 330 responds in the 460 to 620 nanometer range with a peak quantum efficiency of 36% at 520 nm, and bottom photodetector 340 responds in the 580 to 750 nanometer range with a peak quantum efficiency of 31% at 620 nm. Further, each photodetector 310 has a linearity error of approximately 1%. Moreover, photodetectors 310 each have a signal to noise ratio (SNR) that represents the ratio of a desired signal to unwanted noise. In one embodiment, the maximum SNR of photodetectors 310 is approximately 45 decibels (dB).

Photodetectors 310 may be fabricated by selectively changing the doping of an initially positively doped silicon wafer substrate. In the exemplary embodiment, to define a deep n-well region in the p-substrate, the silicon wafer substrate is doped with a high concentration of arsenic atoms. By controlling the doping time and concentration, a 2 μm deep n-well is formed. Next, a small region within the n-well region is doped with a high concentration of boron atoms, effectively reversing its polarity in this region. Hence, a p-well region is formed within the n-well region and has a depth of approximately 0.6 μm. Finally, an n-doped region is formed within the p-well region by doping the silicon with a high concentration of arsenic atoms to a depth of 0.2 μm. A thermal annealing process follows the alternating doping of the silicon. During the thermal annealing, the dopant atoms diffuse and expand each junction by approximately 10 nm. As a monolayer doping technique is used for forming the alternating junctions, a relatively sharp spatial decay of less than 20 nm between junctions may be achieved.

Photodetector assembly 128 includes three back-to-back p-n junctions capable of sensing spectral properties of incoming light. Individual photodetectors 330, 340, and 350 are coupled to a source-follower amplifier and an address switch transistor for, respectively, buffering and individually accessing each photodetector, or photo-diode, 330, 340, and 350 in detection assembly 120. Photodetector assembly 128 may include any number of photodetectors at any depth, and more specifically, may include more than, or fewer than, three photodetectors 310. More particularly, photodetectors 310 may be configured to detect light in any spectrum, such as infrared, orange, etc.

The photoresponse of each pixel 130 within super-pixel 140 with different polarization filters 124 as well as different stacked photodetectors 310 obey Malus's law of polarization, i.e. the intensity of a polarization pixel is defined as:

I_{θ}=cos²(θ=φ), (Eq. 7)

where θ is the polarizer's transmission axis and φ is the incident angle of polarization. Therefore, the 0° pixel response should be maximum at φ=0°, and similarly for the other polarizer pixel responses. However, this may not always be the case due to the effects of both optical and electrical cross talk. Electrical cross talk may be pronounced in this type of spectral sensor. This can be mitigated by installing trenches between pixels 130 in order to capture stray charges generated deep in the substrate and/or by limiting the depth of the silicon substrate. The extinction ratio, which is the ratio of the maximum polarization response to the minimum polarization response, and therefore overall polarimetric performance of the sensor, can be enhanced through calibration. For example, in one embodiment, the extinction ratio of middle photodetector 330 is approximately 3.5. Calibration compensates for physical effects such as imperfections in the nanowires and optical crosstalk.

Reference is made to U.S. Pat. Nos. 5,965,875 and 6,632,701, both to Merrill, which are both hereby incorporated by reference in their entireties.

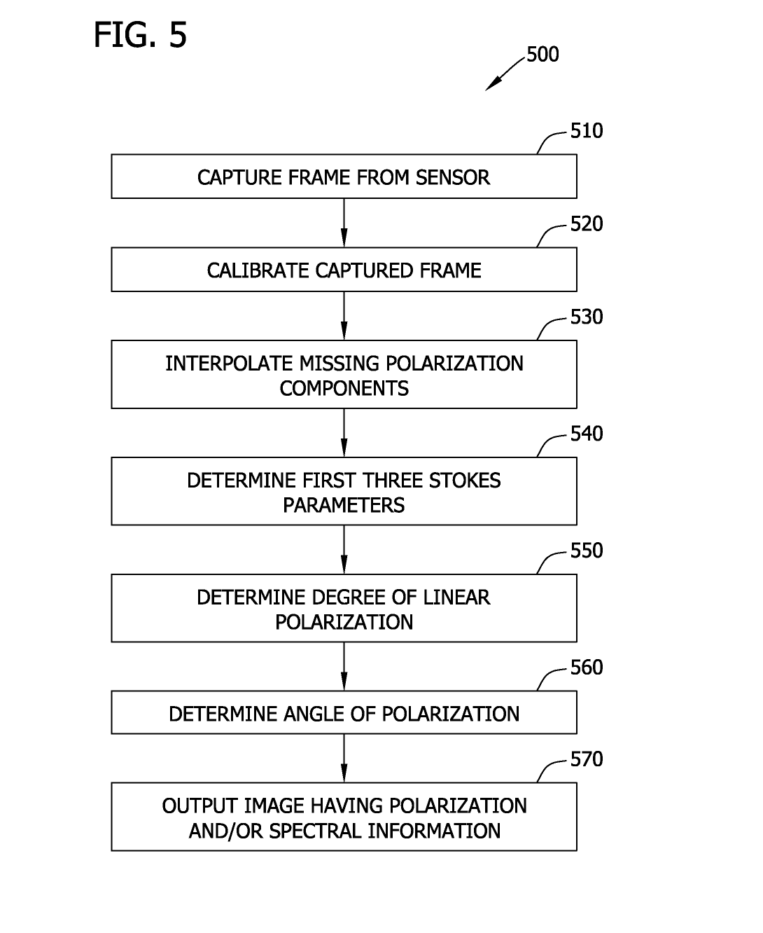

FIG. 5 is a flowchart 500 illustrating an exemplary method for use with sensor 100. More particularly, flowchart 500 illustrates a method for measuring polarization and spectral information using sensor 100. Initially, a frame is captured 510 using sensor 100. More particularly, data from detection assembly 120 is received. As suggested by FIGS. 4A and 4B, the spectral response of detection assembly 120 may be non-linear. In addition, the responsivity curve of detection assembly 120 may include areas of overlap. A calibration step 520 may be performed on the captured frame to make the output of detection assembly 120 suitable for the human visual system.

Each pixel 130 only has one polarization component, and the captured frame may be interpolated 530 to determine all four polarization components for each pixel 130. For example, bilinear interpolation may be used to determine the three unknown polarizations components for a single pixel 130. For a pixel having a 90° polarization component (see Table 1), the other three components may be calculated using

I₀^{P}(2,2)=¼(I₀(1,1)+I₀(1,3)+I₀(3,3)+I₀(3,3)), (Eq. 8)

I₄₅^{P}(2, 2)=½(I₄₅(1,2)+I₄₅(3,2)), (Eq. 9)

I₁₃₅^{P}(2,2)=½(I₁₃₅(2,1)+I₁₃₅(2,3)), (Eq. 10)

For a pixel having a 135° polarization component (see Table 1), the other three components may be calculated using

I₄₅^{P}(2,3)=¼(I₄₅(1,2)+I₄₅(3,2)+I₄₅(1,4)+I₄₅(3,4)), (Eq. 11)

I₀^{P}(2,3)=½(I₀(1,3)+I₀(3,3)), (Eq. 12)

I₉₀^{P}(2,2)=¼(I₉₀(2, 2)+I₉₀(2,4)). (Eq. 13)

TABLE 1

| | | | |
|---|---|---|---|
| I₀(1, 1) | I₄₅(1, 2) | I₀(1, 3) | I₄₅(1, 4) |
| I₁₃₅(2, 1) | I₉₀(2, 2) | I₁₃₅(2, 3) | I₉₀(2, 4) |
| I₀(3, 1) | I₄₅(3, 2) | I₀(3, 3) | I₄₅(3, 4) |
| I₁₃₅(4, 1) | I₉₀(4, 2) | I₁₃₅(4, 3) | I₉₀(4, 4) |

Alternatively, or additionally, one-dimensional bilinear interpolation and/or one-dimensional bilinear spline interpolation may be used. Alternatively, or additionally, bicubic spline interpolation may be used according to this relationship:

fᵢ(x)=aᵢ+bᵢ(x−i)+cᵢ(x−i)²+d₁(x−i)³, ∀x ∈ [i,i+2]. (Eq. 14)

Bicubic spline interpolation may be applied to a one-dimensional case through two rounds: one round for a row and one round for a column. Alternatively, or additionally, any interpolation technique, method, and/or algorithm, whether now known or developed in the future, may be used, such as bicubic interpolation, adaptive interpolation, gradient based interpolation, and/or any interpolation that enables sensor 100 to function as described herein.

The first three Stokes' parameters, e.g., Eqs. 1-3, may be determined 540, as described herein. The degree of linear polarization may be determined 550, as described herein. The angle of polarization may be determined 560, as described herein. More particularly, the Stokes' parameters, degree of linear polarization, and angle of polarization may each be determined for each pixel 130 using interpolated polarization components. An image including polarization and/or spectral information may be generated and output 570. The image is based on the captured frame, and may be calibrated and/or interpolated, as described herein. While interpolation and calibration are not required, interpolation and calibration improve the quality of the captured frame and/or the generated image.

In the example of FIG. 5, operations 510-570 are illustrated in sequential order. However, it should be appreciated that flowchart 500 illustrates non-limiting examples of operations. For example, two or more operations of the operations 510-570 may be executed in a partially or completely overlapping or parallel manner. In other examples, operations may be performed in a different order than that shown. Further, additional or alternative operations may be included. Moreover, more than one iteration of steps 510-570 may be performed, e.g., to capture video, i.e., sequential frames, using sensor 100.

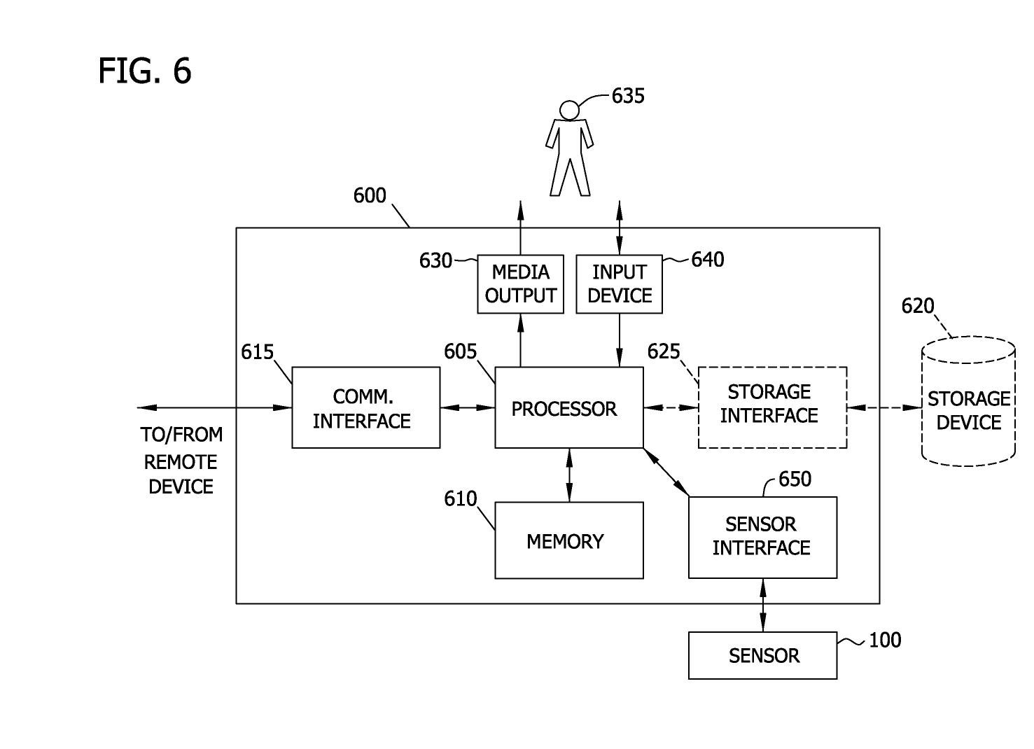

FIG. 6 illustrates an exemplary configuration of a computing device 600 that may be used with sensor 100, e.g., to implement flowchart 500.

Computing device 600 includes a processor 605 for executing instructions. Instructions may be stored in a memory area 610, for example. Processor 605 may include one or more processing units (e.g., in a multi-core configuration) for executing instructions. The instructions may be executed within a variety of different operating systems on the computing device 600, such as UNIX, LINUX, Microsoft Windows®, etc. It should also be appreciated that upon initiation of a computer-based method, various instructions may be executed during initialization. Some operations may be required in order to perform one or more processes described herein, while other operations may be more general and/or specific to a particular programming language (e.g., C, C#, C++, Java, or other suitable programming languages, etc).

Processor 605 is operatively coupled to a communication interface 615 such that computing device 600 is capable of communicating with a remote device such as a user system or another computing device 600. Communication interface 615 may include, for example, a wired or wireless network adapter or a wireless data transceiver for use with a mobile phone network, Global System for Mobile communications (GSM), 3G, or other mobile data network or Worldwide Interoperability for Microwave Access (WIMAX).

Processor 605 may also be operatively coupled to a storage device 620. Storage device 620 is any computer-operated hardware suitable for storing and/or retrieving data. In some embodiments, storage device 620 is integrated in computing device 600. For example, computing device 600 may include one or more hard disk drives as storage device 620. In other embodiments, storage device 620 is external to computing device 600 and may be accessed by a plurality of computing devices 600. For example, storage device 620 may include multiple storage units such as hard disks or solid state disks in a redundant array of inexpensive disks (RAID) configuration. Storage device 620 may include a storage area network (SAN) and/or a network attached storage (NAS) system.

In some embodiments, processor 605 is operatively coupled to storage device 620 via a storage interface 625. Storage interface 625 is any component capable of providing processor 605 with access to storage device 620. Storage interface 625 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 605 with access to storage device 620.

Computing device 600 may also include at least one media output component 630 for presenting information, e.g., images, to a user 635. Media output component 630 is any component capable of conveying information to user 635. In some embodiments, media output component 630 includes an output adapter such as a video adapter and/or an audio adapter. An output adapter is operatively coupled to processor 605 and operatively couplable to an output device such as a display device, a liquid crystal display (LCD), organic light emitting diode (OLED) display, or “electronic ink” display, or an audio output device, a speaker or headphones.

In some embodiments, computing device 600 includes an input device 240 for receiving input from user 635. Input device 640 may include, for example, a keyboard, a pointing device, a mouse, a stylus, a touch sensitive panel, a touch pad, a touch screen, a gyroscope, an accelerometer, a position detector, or an audio input device. A single component such as a touch screen may function as both an output device of media output component 630 and input device 640.

Computing device 600 may include a sensor interface 650 for operatively and/or communicatively coupling processor 605 to sensor 100. Sensor interface 650 may include any interface, bus, interconnect, communication gateway, port, and/or any other component capable of providing processor 605 with access to sensor 100.

Memory area 610 may include, but are not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are exemplary only, and are thus not limiting as to the types of memory usable for storage of a computer program.

Stored in memory area 610 are, for example, computer readable instructions for providing a user interface to user 635 via media output component 630 and, optionally, receiving and processing input from input device 640, sensor interface 650, and/or sensor 100. A user interface may include, among other possibilities, an image viewer and client application. Image viewers enable users, such as user 635, to display and interact with media and other information received from sensor 100. A client application allows user 635 to interact with sensor 100, e.g., requesting a frame to be captured.

All of the compositions and/or methods disclosed and claimed herein may be made and/or executed without undue experimentation in light of the present disclosure. While the compositions and methods of this disclosure have been described in terms of the embodiments included herein, it will be apparent to those of ordinary skill in the art that variations may be applied to the compositions and/or methods and in the steps or in the sequence of steps of the method described herein without departing from the concept, spirit, and scope of the disclosure. All such similar substitutes and modifications apparent to those skilled in the art are deemed to be within the spirit, scope, and concept of the disclosure as defined by the appended claims.

It will be understood by those of skill in the art that information and signals may be represented using any of a variety of different technologies and techniques (e.g., data, instructions, commands, information, signals, bits, symbols, and chips may be represented by voltages, currents, electromagnetic waves, magnetic fields or particles, optical fields or particles, or any combination thereof). Likewise, the various illustrative logical blocks, modules, circuits, and algorithm steps described herein may be implemented as electronic hardware, computer software, or combinations of both, depending on the application and functionality. Moreover, the various logical blocks, modules, and circuits described herein may be implemented or performed with a general purpose processor (e.g., microprocessor, conventional processor, controller, microcontroller, state machine or combination of computing devices), a digital signal processor (“DSP”), an application specific integrated circuit (“ASIC”), a field programmable gate array (“FPGA”) or other programmable logic device, discrete gate or transistor logic, discrete hardware components, or any combination thereof designed to perform the functions described herein. Similarly, steps of a method or process described herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. Although preferred embodiments of the present disclosure have been described in detail, it will be understood by those skilled in the art that various modifications can be made therein without departing from the spirit and scope of the disclosure as set forth in the appended claims.

A controller, computing device, or computer, such as described herein, includes at least one or more processors or processing units and a system memory. The controller typically also includes at least some form of computer readable media. By way of example and not limitation, computer readable media may include computer storage media and communication media. Computer storage media may include volatile and nonvolatile, removable and non-removable media implemented in any method or technology that enables storage of information, such as computer readable instructions, data structures, program modules, or other data. Communication media typically embody computer readable instructions, data structures, program modules, or other data in a modulated data signal such as a carrier wave or other transport mechanism and include any information delivery media. Those skilled in the art should be familiar with the modulated data signal, which has one or more of its characteristics set or changed in such a manner as to encode information in the signal. Combinations of any of the above are also included within the scope of computer readable media.

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A sensor for measuring polarization and spectral information, said sensor comprising:
a polarization assembly including a plurality of polarization filters; and
a detection assembly coupled to said polarization assembly, said detection assembly including a plurality of photodetector assemblies, each photodetector assembly including at least two vertically-stacked photodetectors, wherein each of said plurality of photodetector assemblies is adjacent to one of said plurality of polarization filters.

2. A sensor in accordance with claim 1, wherein each photodetector assembly includes three vertically-stacked photodetectors.

3. A sensor in accordance with claim 2, wherein a first photodetector is positioned at a depth of about 0.2 micrometers, a second photodetector is positioned at a depth of about 0.56 micrometers, and a third photodetector is positioned at a depth of about 2 micrometers.

4. A sensor in accordance with claim 1, further comprising a first pixel that includes a first polarization filter and a first photodetector assembly.

5. A sensor in accordance with claim 4, further comprising a super-pixel that includes said first pixel, a second pixel having a second polarization filter, a third pixel having a third polarization filter, and a fourth pixel having a fourth polarization filter, wherein said first polarization filter is oriented in a first direction, said second polarization filter is oriented in a second direction, said third polarization filter is oriented in a third direction, and said fourth polarization filter is oriented in a fourth direction.

6. A sensor in accordance with claim 5, wherein said first direction is about 0 degrees, said second direction is about 45 degrees, said third direction is about 90 degrees, and said fourth direction is about 135 degrees.

7. A sensor in accordance with claim 1, wherein said plurality of polarization filters comprise nanowires.

8. A sensor in accordance with claim 1, wherein said detection assembly is capable of measuring spectral information including red, green, and blue components.

9. A system for measuring polarization and spectral information, said system comprising:
a sensor comprising:
a polarization assembly including a plurality of polarization filters; and
a detection assembly coupled to said polarization assembly, said detection assembly including a plurality of photodetector assemblies, each photodetector assembly including at least two vertically-stacked photodetectors, wherein each of said plurality of photodetector assemblies is adjacent to one of said plurality of polarization filters; and
a computing device communicatively coupled to said sensor, wherein said computing device is programmed to receive polarization and spectral information from said sensor.

10. A system in accordance with claim 9, wherein each photodetector assembly includes three vertically-stacked photodetectors.

11. A system in accordance with claim 10, wherein a first photodetector is positioned at a depth of about 0.2 micrometers, a second photodetector is positioned at a depth of about 0.56 micrometers, and a third photodetector is positioned at a depth of about 2 micrometers.

12. A system in accordance with claim 9, further comprising a first pixel that includes a first polarization filter and a first photodetector assembly.

13. A system in accordance with claim 12, further comprising a super-pixel that includes said first pixel, a second pixel having a second polarization filter, a third pixel having a third polarization filter, and a fourth pixel having a fourth polarization filter, wherein said first polarization filter is oriented in a first direction, said second polarization filter is oriented in a second direction, said third polarization filter is oriented in a third direction, and said fourth polarization filter is oriented in a fourth direction.

14. A system in accordance with claim 13, wherein said first direction is about 0 degrees, said second direction is about 45 degrees, said third direction is about 90 degrees, and said fourth direction is about 135 degrees.

15. A system in accordance with claim 9, wherein said plurality of polarization filters comprise nanowires.

16. A system in accordance with claim 9, wherein said detection assembly is capable of measuring spectral information including red, green, and blue components.

17. A method for measuring polarization and spectral information, said method comprising:
receiving data from a sensor, wherein the sensor includes a polarization assembly including a plurality of polarization filters and a detection assembly coupled to the polarization assembly, the detection assembly including a plurality of photodetector assemblies, each photodetector assembly including at least two vertically-stacked photodetectors, wherein each of the plurality of photodetector assemblies is adjacent to one of the plurality of polarization filters; and
generating an image having polarization and spectral information based on the received data.

18. A method in accordance with claim 17, further comprising interpolating polarization components for each photodetector assembly based on the received data.

19. A method in accordance with claim 18, further comprising determining Stokes parameters using interpolated polarization components and determining a degree of linear polarization for each photodetector assembly using the Stokes parameters.

20. A method in accordance with claim 19, further comprising determining an angle of polarization for each photodetector assembly using the Stokes parameters.
